(19) United States
(12) Patent Application Publication
(10) Pub. No.: US 2020/0107589 A1
(43) Pub. Date: Apr. 9, 2020

(54) PROTECTIVE NURSING GARMENT

(71) Applicant: Kaitlan McKinley, Quemado, NM (US)

(72) Inventor: Kaitlan McKinley, Quemado, NM (US)

(21) Appl. No.: 16/152,377

(22) Filed: Oct. 4, 2018

(51) Int. Cl. A41D 1/215; A41D 27/12; A41B 13/10; B32B 5/26

(52) U.S. Cl. CPC A41D 1/215; A41D 27/12; A41C 3/04; B32B 5/26; A41B 13/10

(57) ABSTRACT

A protective nursing garment including a bib member for attachment to an upper body area of a wearer. The bib member includes a body having a front layer and back layer with an internal filler therebetween. The body of the bib member includes a plurality of horizontally stitched lines throughout the body to retain the placement of the internal filler. The body includes a top portion, a middle portion and a bottom portion. The top portion is positioned over a shoulder area and extends down a backside of the upper body area to a middle back area and extends down a frontside of the upper body area to a top region of a breast area to absorb staining particles presented on the frontside and backside of the upper body area above the breast area. The middle portion includes a cut out region in the body, the cut out region is positioned around the breast area so that the middle portion of the bib member surrounds the outside breast area. The bottom portion extends downward from the middle portion so that the bottom of the bib member is positioned underneath the breast area to absorb staining particles presented beneath the breast. The bottom portion has a width wider than the top portion. The width of the bottom portion is wide enough to provide full coverage from staining particles across the full width of the breast area.

### FIELD OF THE INVENTION

Embodiments described herein generally relate to apparel for nursing mothers, and more particularly to a protective nursing garment.

### BACKGROUND OF THE INVENTION

A bib is a garment worn generally hanging from the neck on the chest to protect clothing from accidentally spilled food. Bibs are frequently used by young children, especially infants, but also by some adults. A good baby bib not only protects a child's clothes but also saves parents from hours of laundering. Most bibs on the market fail when it comes to protecting clothes from milk stains and/or drool when caring for a child. Thus, it is desirable to provide a bib that not only protects from spills, baby drool and burp, but also from milk stains from the breast during and after feeding the baby.

### BRIEF DESCRIPTION OF THE DRAWINGS

The various advantages of the embodiments of the present disclosure will become apparent to one skilled in the art by reading the following specification and appended claims, and by referencing the following drawings, in which:

FIG. 1 shows an exemplary protective nursing garment according to an embodiment of the present disclosure.

FIG. 2 shows another exemplary view of the protective nursing garment attached to a wearer according to an embodiment of the present disclosure.

FIG. 3 shows a cross sectional view of a protective nursing garment according to an embodiment of the present disclosure.

### SUMMARY OF THE INVENTION

Exemplary embodiments disclosed herein describe a protective nursing garment. The protective nursing garment including a bib member for attachment to an upper body area of a wearer. The bib member includes a body having a front layer and back layer with an internal filler therebetween. The body of the bib member includes a plurality of horizontally stitched lines throughout the body to retain the placement of the internal filler. The body includes a top portion, a middle portion and a bottom portion. The top portion is positioned over a shoulder area and extends down a backside of the upper body area to a middle back area and extends down a frontside of the upper body area to a top region of a breast area to absorb staining particles presented on the frontside and backside of the upper body area above the breast area. The middle portion includes a cut out region in the body, the cut out region is positioned around the breast area so that the middle portion of the bib member surrounds the outside breast area. The bottom portion extends downward from the middle portion so that the bottom of the bib member is positioned underneath the breast area to absorb staining particles presented beneath the breast. The bottom portion has a width wider than the top portion. The width of the bottom portion is wide enough to provide full coverage from staining particles across the full width of the breast area.

In some exemplary embodiments, the bottom portion of the bib member includes a flap that folds over a bra and under the breast when the bra is folded down.

In some exemplary embodiments, the body of the bib is tapered.

In some exemplary embodiments, the bottom portion of the bib member has a semicircle shaped bottom edge.

In some exemplary embodiments, the front layer and the back layer are each thin layers of fabric.

In some exemplary embodiments, the front layer and the back layer of the body include a stain absorbent fabric.

In some exemplary embodiments, the stain absorbent fabric is flannel.

In some exemplary embodiments, the internal filler is cotton batting.

### DETAILED DESCRIPTION

The present disclosure relates to a protective nursing garment which provides protection from staining particles when nursing/caring for the baby and when feeding the baby. The protective nursing garment is positioned to go from your shoulder, around the breast on the outside and back under the breast where it can be tucked over a folded down nursing bra. This positioning allows any excess milk to drain and soak into the protective nursing garment instead of the wearer's bra or shirt. This positioning also allows a nursing mother (i.e. the wearer) to go immediately from nursing to burping while having a protective cloth already built in the protective garment for both activities. The top portion of the protective nursing garment can also be handy for if the baby spits up while nursing and the mother needs something fast to clean up the mess.

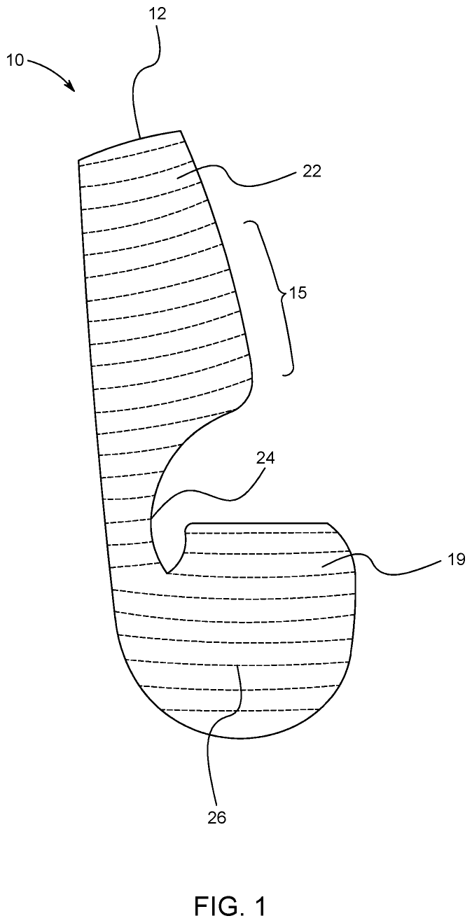

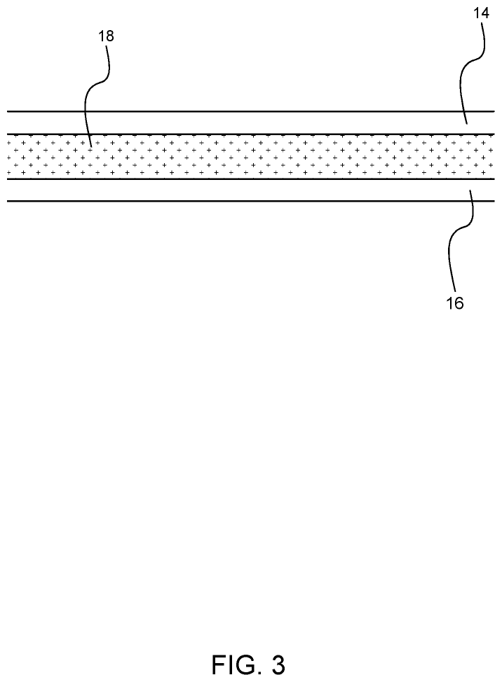

As illustrated in FIGS. 1-3, an exemplary protective nursing garment 10 includes a bib member 12 for attachment to an upper body area 20 of a wearer. The bib member 12 includes a body having a front layer 14 and back layer 16 with an internal filler 18 therebetween. The front layer and the back layer may be made from any suitable stain absorbent fabric. In a preferred embodiment, the front layer and back layer are each thin layers of fabric. Further, in a preferred embodiment, the front layer and back layer are both made of flannel. The internal filler may be made from any suitable filler material. In a preferred embodiment, the internal filler is made of cotton batting.

The body of the bib member 12 includes a plurality of horizontally stitched lines 15 throughout the body to retain the placement of the internal filler. In a preferred embodiment, the body of the bib member is tapered.

The body of the bib member includes a top portion 22, a middle portion 24 and a bottom portion 26. The top portion is positioned over a shoulder area and extends down a backside of the upper body area 20 to a middle back area and extends down a frontside of the upper body area 20 to a top region of a breast area 28 to absorb staining particles presented on the frontside and backside of the upper body area above the breast area.

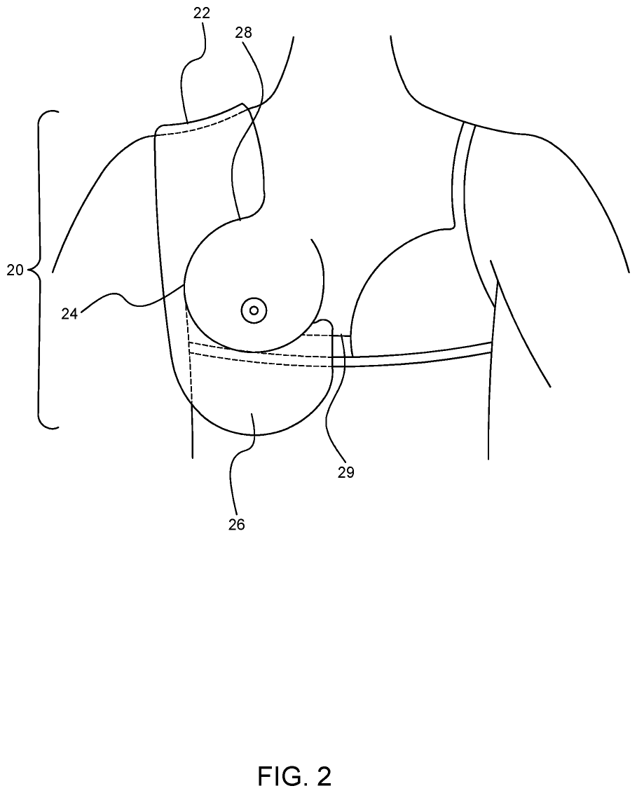

The middle portion 24 includes a cut out region in the body. As illustrated in FIG. 2, the cut out region is positioned around the breast area so that the middle portion of the bib member surrounds the outside breast area.

The bottom portion 26 of the bib member 12 includes a flap 19 that folds over a bra and under the breast when the bra is folded down 29. The bottom portion extends downward from the middle portion 24 so that the bottom of the bib member is positioned underneath the breast area to absorb staining particles presented beneath the breast. The bottom portion has a width wider than the top portion 22. The width of the bottom portion is wide enough to provide full coverage from staining particles across the full width of the breast area. The bottom portion of the bib member has a semicircle shaped bottom edge.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.)

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A protective nursing garment comprising:
a bib member for attachment to an upper body area of a wearer, the bib member including a body having a front layer and back layer with an internal filler therebetween, the body of the bib member including a plurality of horizontally stitched lines throughout to retain the placement of the internal filler, the body including a top portion, a middle portion and a bottom portion, the top portion is positioned over a shoulder area and extends down a backside of the upper body area to a middle back area and extends down a frontside of the upper body area to a top region of a breast area to absorb staining particles presented on the frontside and backside of the upper body area above the breast area, the middle portion includes a cut out region in the body, the cut out region is positioned around the breast area so that the middle portion of the bib member surrounds the outside breast area, the bottom portion extends downward from the middle portion so that the bottom of the bib member is positioned underneath the breast area to absorb staining particles presented beneath the breast, the bottom portion having a width wider than the top portion, the width of the bottom portion is wide enough to provide full coverage from staining particles across the full width of the breast area.

2. The protective nursing garment of claim 1, wherein the bottom portion of the bib member includes a flap that folds over a bra and under the breast when the bra is folded down.

3. The protective nursing garment of claim 1, wherein the body of the bib member is tapered.

4. The protective nursing garment of claim 1, wherein the bottom portion of the bib member has a semicircle shaped bottom edge.

5. The protective nursing garment of claim 1, wherein the front layer and the back layer are each thin layers of fabric.

6. The protective nursing garment of claim 1, wherein the front layer and the back layer include a stain absorbent fabric.

7. The protective nursing garment of claim 6, wherein the stain absorbent fabric is flannel.

8. The protective nursing garment of claim 1, wherein the internal filler is cotton batting.
